(19) United States
(12) Patent Application Publication
(10) Pub. No.: US 2019/0039156 A1
(43) Pub. Date: Feb. 7, 2019

(54) BLADE HOLDER WITH ADJUSTING SLIDE

(71) Applicant: Dienes Werke für Maschinenteile GmbH & Co. KG, Overath (DE)

(72) Inventor: Rudolf Supe-Dienes, Overath (DE)

(21) Appl. No.: 16/053,549

(22) Filed: Aug. 2, 2018

(30) Foreign Application Priority Data
Aug. 2, 2017 (DE) 10 2017 117 524.5

(51) Int. Cl. B23D 45/02

(52) U.S. Cl. CPC B23D 45/021

(57) ABSTRACT

A blade holder (1) for a longitudinal cutting machine includes a rotatably mounted blade head (3) for holding a circular blade (4) and at least one locking device (2). At least one actuator actuates an element of the blade holder (1), and a moveably mounted adjusting slide (5) positions the blade head (3) on the longitudinal cutting machine. The adjusting slide (5) for positioning of the blade head (3) is moveable from a starting position to a positioning point. With the blade holder, materials can be cut perfectly with high precision. In particular, materials such as tissue, non-woven materials, paper, OLED film, displays, battery film, lithium batteries, aluminum, copper film, anodes, and cathodes can be cut.

### CROSS-REFERENCE TO RELATED APPLICATION

This application claims the priority date of Aug. 2, 2017, the filing date of the German patent application DE 10 2017 117 524.5.

### BACKGROUND OF THE INVENTION

The present invention relates to a blade holder for a longitudinal cutting machine, with a rotatably mounted blade head for holding a circular blade, with at least one hold-open device, in particular, for fixing the blade holder to a traverse of the longitudinal cutting machine, with at least one actuator for actuation of an element of the blade holder, and with a moveably mounted adjusting slide for, in particular, manual positioning of the blade head relative to the longitudinal cutting machine, whereby the adjusting slide is moveable for positioning of the blade head from a starting position into a positioning point.

Applicant intends that the phrase “easy set” refers to blade holders with the above-described features. For example, Applicant refers to the blade holder with the type designation PSGm 25 DF and PSGm 19 DF, which can be equipped with an adjusting slide. The adjusting slide, for positioning of the blade holder on the longitudinal cutting machine, is placed downward, so that a part of the adjusting slide, by displacement of the blade holder along the traverse, can be brought into contact with a cutting edge of a lower blade. In this manner, an exact orientation of the blade holder of the upper blade to the lower blade along the traverse is possible. If the blade head of the positioned blade holder is lowered automatically for the cutting process, it was proven that the adjusting slide, which is not moved back inadvertently into its starting position, can negatively effect the cutting process.

### SUMMARY OF THE INVENTION

An object of the present invention, therefore, is to resolve the disadvantages associated with the state of the art and in particular, to provide a blade holder, whose adjusting slide cannot impede the cutting process.

The object is solved, in particular, by a blade holder with the above-noted features, whereby the adjusting slide is coupled with a locking device, which prevents actuation of the blade holder as soon as the adjusting slider is moved out of its starting position.

It is provided, in particular, that the blade holder cannot be actuated, for example, by a superordinate control unit as long as the adjusting slide is moved out of its starting position. Thus, the blade holder only can be used for a cutting process when the adjusting slide is moved back again into its starting position after positioning of the blade head. In this manner, the lower blade is prevented from being damaged by the adjusting slide that has moved out of its starting position during an adjusting process of the blade head.

For the positioning of the blade head to the longitudinal cutting machine, first the locking device is released, so that blade head is moveable, if necessary commonly with the entire blade holder, relative to the longitudinal cutting machine, and in particular, to a lower blade of the longitudinal cutting machine. Next, the adjusting slide is moved preferably manually from its starting position, in particular, folded out and/or pivoted out, so that the adjusting slide extends in the direction of the lower blade and preferably is arranged laterally near a cutting edge of the lower blade. In this positioning point of the adjusting slide, the blade head is moved until the adjusting slide, for example, with a contact element, comes into contact with the cutting edge or another reference surface of the lower blade. In this contact position, an exact orientation of the blade head relative to the lower blade is provided, so that the adjusting device can again be tightened.

The adjusting slide, in particular, is mounted on the blade holder such that it can be transported only manually from the starting position into the positioning point and back. In the positioning point, the adjusting slide can be brought into contact with a reference mark by movement of the entire blade holder, so that the blade holder is oriented toward the reference mark. With the movement of the adjusting slide from the starting position into the positioning point, the blade holder is not moved, in contrast, relative to another element of a longitudinal cutting machine.

The adjusting device of the blade holder can include, for example, a dovetail guide with a clamping element, with which the blade holder can be moved along a corresponding traverse, in particular, manually, whereby the blade holder is fixed by means of the clamping element into a position on the traverse. After positioning of the blade holder in the axial direction of the traverse and thus, after positioning of the blade head, the blade holder is fixed, in particular. by means of the clamping element of the adjusting device to the traverse.

Alternatively, it can be provided that the blade head is moved relative to a housing of the blade holder connected with the traverse, for example, lowered, until reaching a distance predetermined by the adjusting slide, in particular, a vertical distance, relative to the lower blade. The adjusting device therefore serves in this case for fixing of the blade head relative to a housing of the blade holder. In principal, multiple adjusting devices can be provided.

The blade head can be delivered linearly onto the lower blade before starting the cutting process, for example, by means of a first actuator that preferably can be electro-mechanically, hydraulically, or pneumatically actuated. The adjustment takes place, therefore, in particular, transverse to an axis of rotation of the blade head.

In addition or alternatively, it can be provided that the blade head is engaged by means of a further actuator that preferably can be electro-mechanically, hydraulically or pneumatically actuated in the direction of the extension of the traverse on a cutting edge of the lower blade, whereby this adjustment, in particular, takes place in the direction of the axis of rotation of the blade head.

With such blade holders, materials can be cut perfectly with high precision. In particular, materials such as tissue, non-woven material, paper, OLED film, displays, battery films, lithium batteries, aluminum, copper film, anodes or cathodes can be cut.

In particular, it can be provided that the locking takes place mechanically, when the adjusting slide is moved out from its starting position. For example, a locking element can be moved by the adjusting slide, which engages in the potential path of motion of the element of the blade holder to be locked. Alternatively, a locking element can be brought into engagement with a corresponding recess of associated element of the blade holder. A mechanical interruption of the energy supply of the actuator is likewise conceivable.

It also can be provided that the locking takes place electrically and/or electronically when the adjusting slide is moved out from its starting position. By means of the adjusting slide being moved out from its starting position, for example, at least an indirect actuation of an actuator of the blade holder that adjusts the element could be prevented. Thus, the electrical or pneumatic energy supply, for example, for actuating an actuator electrically or electronically can be prevented when the adjusting slide is moved out from its starting position.

It also can be provided that the locking takes place pneumatically or hydraulically when the adjusting slide is moved out from its starting position. For example, by means of the adjusting slide, pneumatics for actuation of a locking element can be released, which engages in the potential path of motion of the element of the blade holder to be locked.

In particular, a switch can be provided, which is constructed and arranged so that it is activated by the adjusting slide as soon as the adjusting slide is moved out of its starting position, whereby the activated switch releases the locking device. The locking device, therefore, is directly actuated via the switch.

In particular, the locking device can be embodied such that an energy supply to at least one of the multiple actuators, if necessary, of the blade holder is interrupted. In this regard, for example, a corresponding pneumatic supply to the respective actuator can be interrupted.

In principal, the adjusting slide can be displaceable linearly from the starting position into its positioning point; however, it is preferable that the adjusting slide is pivotably mounted.

The invention relates also to a longitudinal cutting machine with a plurality of blade holders according to the present invention, whereby the blade holders are held as upper blades on a continuous traverse of the longitudinal cutting machine and the multiple blade holders are associated with at least one lower blade, preferably each upper blade is associated with a lower blade.

In this connection, it can be provided that the actuation of the entire longitudinal cutting machine is prevented when the adjusting slide of an individual blade holder is moved out from its starting position. This can be achieved, for example, if the adjusting slide of each blade holder is coupled with a superordinate control.

### BRIEF DESCRIPTION OF THE DRAWINGS

The invention and the technical field are described next with reference to the figures. In the figures:

FIG. 1 shows a perspective view of a blade holder with an adjusting slide in a starting position;

FIG. 2 shows a side view of the blade holder according to FIG. 1;

FIG. 3 shows a perspective view of the blade holder with the adjusting slide pivoted out from the starting position; and

FIG. 4 shows a side view of the blade holder according to FIG. 3.

### DETAILED DESCRIPTION OF THE PREFERRED EMBODIMENTS

The blade holder 1 shown in the figures includes a locking device (not shown), with which the blade holder 1 is displaceable along a traverse (not shown) of a longitudinal cutting machine and which can be fixed to this traverse.

The blade holder 1 also includes a blade head 3, to which a circular blade 4 is attached. The blade head can be lowered by means of an actuator.

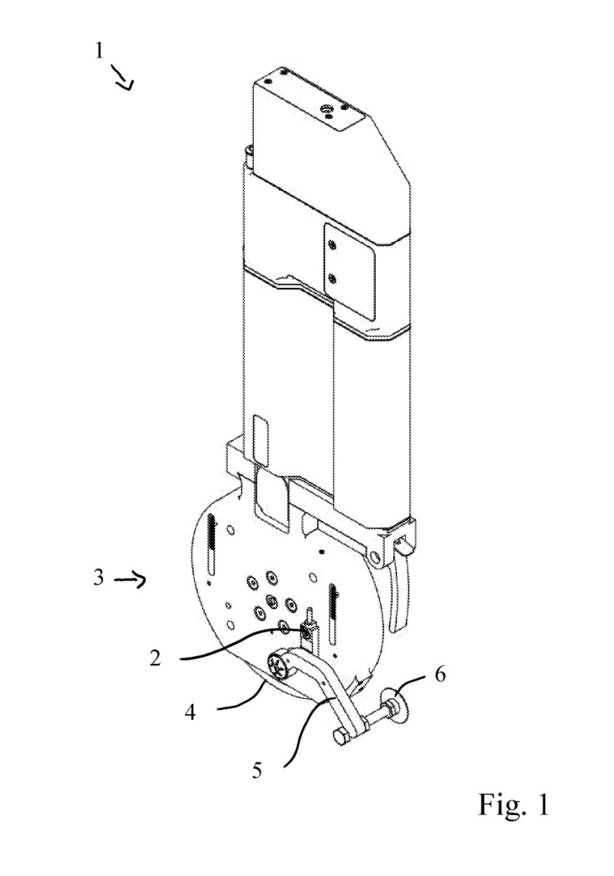

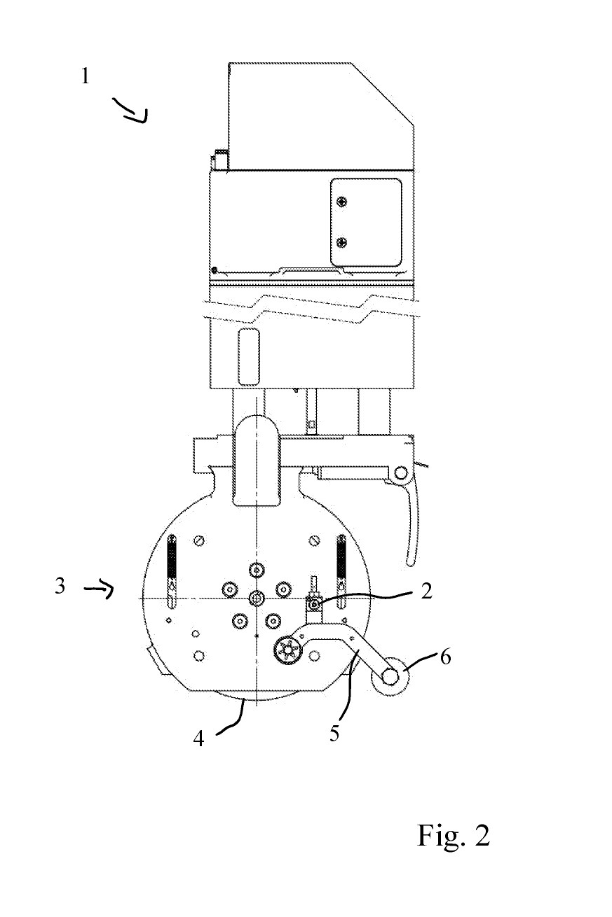

The blade holder 1 also includes an adjusting slide 5 for positioning the blade holder 1 on the traverse. In this connection, the adjusting slide 5 has a contact element 6, whose relative vertical position corresponds with the position of the cutting edge of the circular blade 4. The starting position of the adjusting slide 5 is shown in FIGS. 1 and 2.

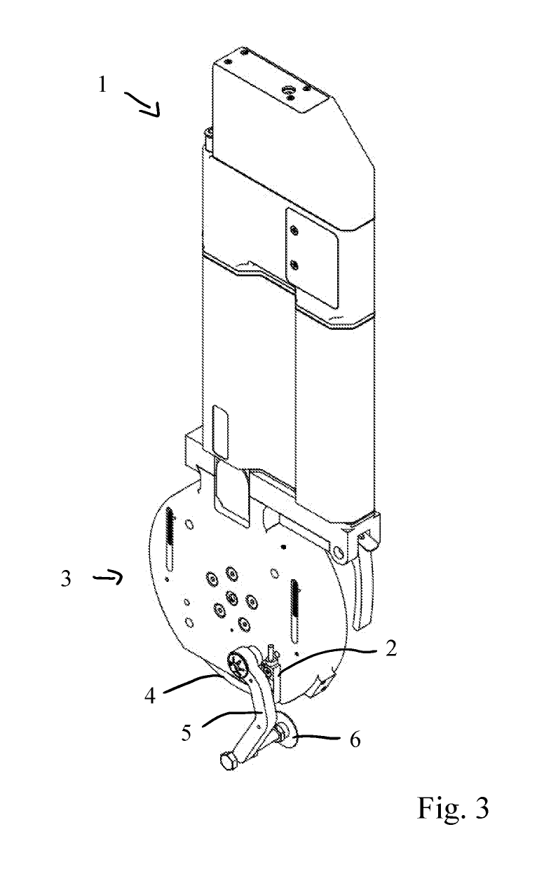

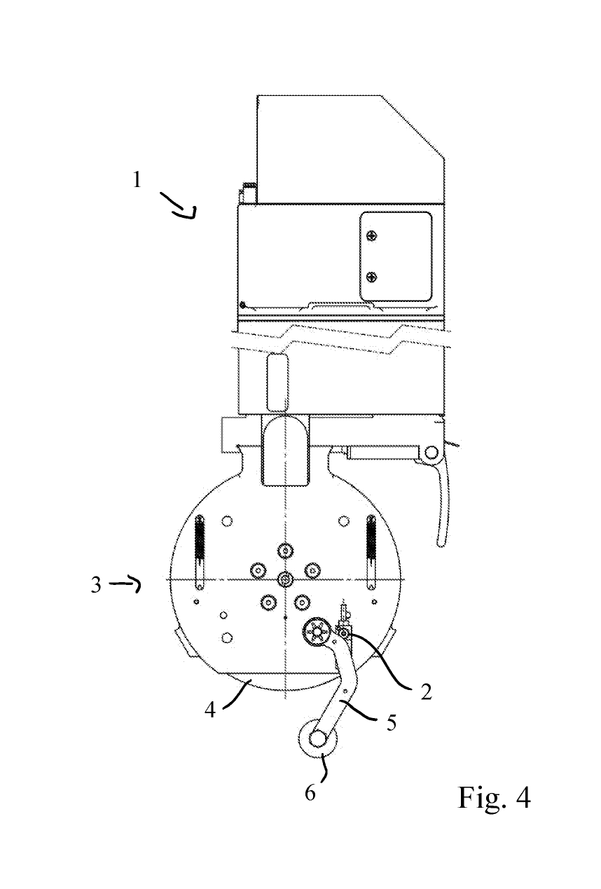

For positioning of the blade holder 1 on the traverse, the adjusting slide 5 is pivoted downward, so that the contact element 6 can be brought into contact with a cutting edge of a lower blade (not shown) (see FIGS. 3 and 4). As soon as the blade holder 1 is positioned on the transverse by contact of the contact element 6 on the cutting edge of the lower blade, it can be fixed by means of a locking device. For the cutting process, the blade head 5 is lowered by means of the actuator.

Locking is now provided, which is activated by means of a switch 2 as soon as the adjusting slide 5 is pivoted out of the starting position shown in the figures. The switch 2 is thereby coupled with the actuator, such that lowering of the blade head 3 with an activated switch 2 is prevented.

The features of the subject matter of this invention set forth in the above description, the patent claims, the abstract and the drawings can be used individually and in any desired combination for the realization of the invention in its various embodiments.

The present invention is, of course, in no way restricted to the specific disclosure of the specification and drawings, but also encompasses any modifications within the scope of the appended claims.

### REFERENCE NUMERALS

1 blade holder
2 switch
3 blade head
4 adjusting slide
6 contact element

We claim:

1. A blade holder (1) for a longitudinal cutting machine, comprising:
a rotatably mounted blade head (3) for holding a circular blade (4);
at least one locking device;
at least one actuator for actuation of an element of the blade holder (1); and
a movably mounted adjusting slide (5) for positioning the blade head (3) relative to the longitudinal cutting machine, wherein the adjusting slide (5) is moveable for positioning of the blade head (3) from a starting position to a positioning point, and wherein the adjusting slide (5) is coupled with a locking device, the locking device being configured to prevent actuation of the blade holder (1) as soon as the adjusting slide (5) is moved out from the starting position.

2. The blade holder (1) according to claim 1, wherein locking takes place mechanically when the adjusting slide (5) is moved out of the starting position.

3. The blade holder (1) according to claim 1, wherein locking takes place electrically and/or electronically when the adjusting slide (5) is moved out of the starting position.

4. The blade holder (1) according to claim 1, wherein locking takes place pneumatically when the adjusting slide (5) is moved out of the starting position.

5. The blade holder (1) according to claim 1, further comprising a switch (2), wherein the switch is configured to be activated by the adjusting slide (5) as soon as the adjusting slide (5) is moved out from the starting position, wherein the switch (2) in an activated state triggers locking.

6. The blade holder (1) according to claim 1, wherein locking interrupts an energy supply to at least one actuator of the blade holder (1).

7. The blade holder (1) according to claim 1, wherein the blade holder (3) is linearly adjustable in the direction of an axis of rotation of the blade holder (3).

8. The blade holder (1) according to claim 1, wherein the blade head (3) is adjustable transverse to an axis of rotation of the blade head (3).

9. The blade holder (1) according to claim 1, wherein the adjusting slide (5) is pivotably mounted.

10. A longitudinal cutting machine with a plurality of blade holders (1) according to claim 1, wherein the blade holders (1) are held as upper blades on a continuous traverse of the longitudinal cutting machine and each of the multiple blade holders (1) is associated with at least one lower blade.

11. The longitudinal cutting machine according to claim 10, wherein actuation of the entire cutting machine is prevented when the adjusting slide (5) of an individual blade holder (1) is moved out of the starting position.
